(19) United States
(12) Patent Application Publication
(10) Pub. No.: US 2007/0127258 A1
(43) Pub. Date: Jun. 7, 2007

(54) PROJECTION LIGHTING APPARATUS FOR MARKING AND DEMARCATION

(75) Inventors: Sean Xiaolu Wang, Wilmington, DE (US); Rongsheng Tian, Newark, DE (US)

Correspondence Address: FRANK F. TIAN, 331-4A THIRD AVENUE, LONG BEACH, NJ, 07740, US

(73) Assignee: BWT PROPERTY, INC., Newark, DE (US)

(21) Appl. No.: 11/567,365

(22) Filed: Dec. 6, 2006

Related U.S. Application Data
(60) Provisional application No. 60/597,515, filed on Dec. 7, 2005.

(51) Int. Cl. G02B 6/32; G02B 6/42

(52) U.S. Cl. 362/559; 362/555; 385/33; 385/93

(57) ABSTRACT

A projection lighting apparatus is disclosed for marking and demarcation applications in airports, waterways, and industrial environments. The lighting apparatus comprises a plurality of high intensity LEDs with their output coupled to the input ends of a plurality of optical fibers. The output ends of the optical fibers are packaged to form a desired illumination pattern. The illumination pattern is projected onto the target surface through a secondary optical system for marking and demarcation enhancement.

### REFERENCE TO RELATED APPLICATIONS

This application claims an invention which was disclosed in Provisional Patent Application No. 60/597,515, filed Dec. 7, 2005, entitled “Projection Lighting Apparatus Utilizing High Intensity LEDs”. The benefit under 35 USC § 119(e) of the above mentioned United States Provisional Applications is hereby claimed, and the aforementioned application is hereby incorporated herein by reference.

### FIELD OF THE INVENTION

This invention generally relates to a lighting apparatus and more specifically to a projection lighting apparatus utilizing high intensity LEDs for marking and demarcation enhancement.

### BACKGROUND

Optical pattern projection apparatus are widely employed in airports, waterways, and industrial environments for traffic control, incursion prevention, etc. It generally comprises a light source to provide illumination and a secondary optical system to project the light from the light source to a target surface to form the desired illumination pattern. The distance between the light source and the target surface may range from a few meters to several tens of meters. Laser based light sources have been used for optical pattern projection applications mainly due to their small beam divergence. Some examples can be found in U.S. Pat. Nos. 3,866,032, 6,007,219, and 6,688,755; respectively issued to Veres and O'Meara.

In U.S. Pat. No. 3,866,032 to Veres, a runway illumination system is described. An illumination system for providing center and edge stripes for an airport runway, in which six laser generating stations are respectively arranged in relationship with the ends of the proposed stripes. Each station includes a below-ground generator for producing a beam of coherent visible radiation, a housing supported above the level of the runway and an upstanding conduit for transmitting the beam to the housing. Within the housing the beam is expanded to the desired width of the stripes and is then collimated to prevent further increase in the beam diameter. The thus modified beam is projected either in a direction parallel to the runway or downwardly toward the runway surface and in a preferred embodiment is caused to oscillate at a frequency in excess of the persistency of vision to produce a continuous visible line on the runway.

In U.S. Pat. No. 6,007,219 to O'Meara, a laser lighting system is provided which employs visible and reflective laser beam lighting sources to provide illumination of airport runways and taxiways, preferred approach and departure routes, seaplane base landing areas, marine waterways, as well as to assist in search and rescue operations. The laser lighting system may be a laser lighting post or a laser lighting unit for providing radiation along a surface that includes at least one laser for producing a beam of coherent visible or reflective radiation, and a glass plano-convex cylindrical lens which has an aspherical convex cylindrical surface for generating a laser line which is uniformly illuminated from end to end. The laser lighting post includes a mounting column which has an access door for providing access to a tilt switch assembly and an AC/DC power adapter unit. The mounting column is attached to a base plate by a frangible coupling. The laser lighting unit includes a case containing a flashlight light bulb, at least one battery, and laser switch means for selectively energizing the laser via the at least one battery. The laser lighting unit also includes a light bulb switch means for selectively energizing the light bulb via the at least one battery. The laser lighting unit may also include an enlarged end to form a head having a front opening which is spanned by a parent lens. The laser lighting unit may also include a parabolic reflector.

In U.S. Pat. No. 6,688,755 to O'Meara, a laser lighting system is disclosed which employs employ visible and reflective laser beam lighting sources to provide illumination of airport runways and taxiways, preferred approach and departure routes, seaplane base landing areas, marine waterways, as well as to assist in search and rescue operations. The lighting system includes handheld laser lighting units or flares particularly useful for search and which have an optic which emits a laser beam for generating a laser line which is uniformly illuminated from end to end. The handheld laser lighting units may have a pistol grip housing or a cylindrical housing, and may feature either a trigger switch, a plunger switch, or a rotary switch. The handheld laser lighting units are battery powered, and include waterproofing seals for protection from the elements.

Recent development of high intensity light emitting diodes (LEDs) makes it possible to utilize LED light sources for projection lighting. As an example, Parker et al. disclose a multimedia projector comprising blue, green and red LEDs or LED arrays in U.S. Pat. No. 6,224,216. In the Parker patent, the light from the LED source is delivered through a fiber bundle to illuminate a display device formed by a digital micro-mirror device (DMD) or a liquid crystal display (LCD) chip. An optical pattern is generated by the display device and projected onto a target plane that is placed a few meters away for presentation purposes. The display device, such as the DMD or LCD chip used in the Parker patent, has a very limited size. Thus the optical pattern generated by the display device has a limited total luminous flux under LED illumination. When such an optical pattern is projected onto a surface a long distance away from the projector, the illuminance level will be very low. In addition, a high lumen loss occurs when the light is delivered from the LED array to the display device due to the relative large divergence angle of the LED light. Therefore the illuminance level and projection range provided by the disclosed multimedia projector are not sufficient for marking and demarcation applications in airports, waterways, and industrial environments.

Therefore, it is desirous to have an optical pattern being generated by a fiber array instead of a display device as disclosed in the prior art such as the Parker patent. Thus the total luminous flux of the optical pattern is no longer limited by the size of the display device. In addition, the high lumen loss induced by the incorporation of a display device is avoided. Furthermore, a LED to fiber coupling stage is also provided or designed to achieve a high light coupling efficiency.

### SUMMARY OF THE INVENTION

It is thus the overall goal of the current invention to provide an LED based projection lighting apparatus that produce a high illuminance level and a large projection range, which meet the requirements for marking and demarcation enhancement in airports, waterways, and industrial environments.

In the present invention, the optical pattern is generated by a fiber array instead of a display device. Thus the total luminous flux of the optical pattern is no longer limited by the size of the display device. In addition, the high lumen loss induced by the incorporation of a display device is avoided. The LED to fiber coupling stage is also designed to achieve a high light coupling efficiency.

The lighting apparatus comprises a plurality of fiber coupled high intensity LEDs. The output ends of the optical fibers are packaged to form a desired illumination pattern. The light emitted from the output ends of the fibers is collected and projected onto the target surface through a secondary optical system comprising a group of lenses. The projection range may vary from a few meters to several tens of meters depending on the application requirements.

The high intensity LEDs employed in the present invention adopt a chip-on-board (COB) packaging configuration, where the LED chips are directly surface mounted on a thermal conductive substrate for improved heat dissipation. The COB package allows larger light emitting surface and higher drive current for the LED chip to increase its output power. The COB packaging also leads to long lifespan or lifetime, as well as wavelength and intensity stability. The optical fibers are designed to have a suitable numerical aperture (NA) and a core diameter to match with the divergence angle and size of the LED light beam so that a high coupling efficiency can be achieved.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates the structure of one exemplary LED projection lighting apparatus.

FIG. 2 illustrates one exemplified operation mode of the LED projection lighting apparatus.

FIG. 3 illustrates an exemplified structure of the LED to fiber coupling stage.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a projection lighting apparatus utilizing high intensity LEDs. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

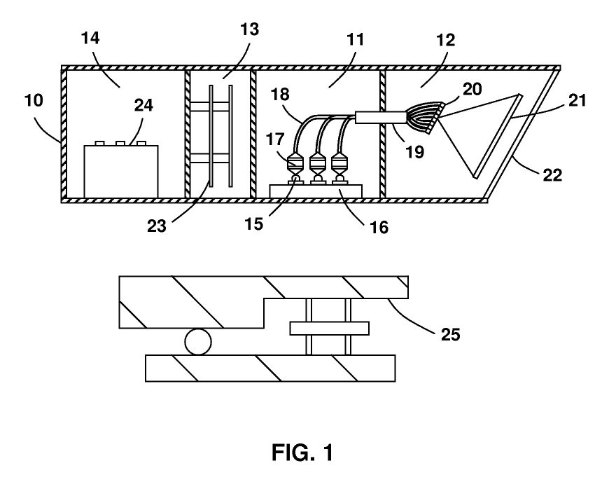

One exemplary embodiment of the current invention is illustrated in FIG. 1. The projection lighting apparatus 10 comprises a waterproof housing with four compartments, i.e. an LED compartment 11, a light projection compartment 12 receiving light from the LED compartment 11 and processing the received light suitable for use. The projection lighting apparatus 10 further comprises an electronic compartment 13 and an optional battery compartment 14. The LED compartment 11 further comprises a plurality of chip-on-board (COB) packaged high intensity LEDs 15 mounted on an aluminum heat sink 16. In the COB package, the LED chips are directly surface mounted on a thermal conductive substrate for improved heat dissipation. The COB package allows larger light emitting surface and higher drive current for the LED chip to increase its output power. The COB package also leads to long lifespan or lifetime, as well as wavelength and intensity stability. In the present embodiment, the LEDs 15 have a light emitting surface of around 1 mm² and produce a luminous flux of >110 lumen in the wavelength range of about 585-600 nm (i.e. amber color). The light emitted from each LED 15 is first collected by a group of lenses 17 each associated with their corresponding LEDs 15 and then each is respectively coupled into an optical fiber 18 with a numerical aperture (NA) of 0.51 and a core diameter matched with the size of the LED chip. In the present embodiment, the fibers 18 have a core diameter of about 1.5 mm to couple >40% of the LED light into the fiber. The fibers 18 are packed into a fiber bundle 19 to deliver the LED light from the LED compartment 11 to the light projection compartment 12. In the light projection compartment 12, the output ends of the fibers are packaged to form a fiber array 20 and placed at around the focal plane of an optical lens 21, e.g. a Fresnel lens. In the present embodiment, the fiber array 20 is packaged to form a line shaped optical pattern. Skilled person will appreciate that other complex optical patterns can be formed with the fiber array. The optical lens 21 has a relatively large diameter and numerical aperture (NA) for efficiently collecting the light emitted from the fiber array 20. The collected light is projected onto the target surface through a transparent window 22 to form an illuminated line pattern for marking and demarcation. The LEDs 15 are driven and controlled by an electronic circuit board 23 in the electronic compartment 13. The electronic circuit board 23 can be powered by an external power supply (not shown) or by a rechargeable battery 24 in the battery compartment 14. The whole projection lighting apparatus 10 is mounted on an adjustable mounting unit 25 for height and elevation angle control.

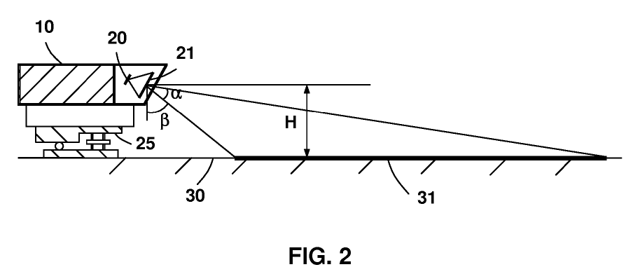

The operation scheme of the projection lighting apparatus is further illustrated in FIG. 2. The optical lens 21 is employed to produce an image of the LED illuminated fiber array 20. The image is projected onto the target surface 30 to form a line pattern 31. The length of the line pattern 31 is determined by the length of the fiber array 20, and the height (H) and projection angle (β+α/2) of the lighting apparatus 10. The width of the line pattern is determined by the diameter of the fibers 18 and the focal length of the optical lens 21. The parameters of the illuminated line pattern can be fine tuned by adjusting the height and elevation angle of the adjustable mounting unit 25. In addition, the uniformity of the line pattern 31 can be improved by adjusting the relative intensity of the LEDs 15, the packing density of the fiber array 20, and/or incorporating additional optical components, such as a cylindrical lens between the fiber array 20 and the optical lens 21 for light intensity control.

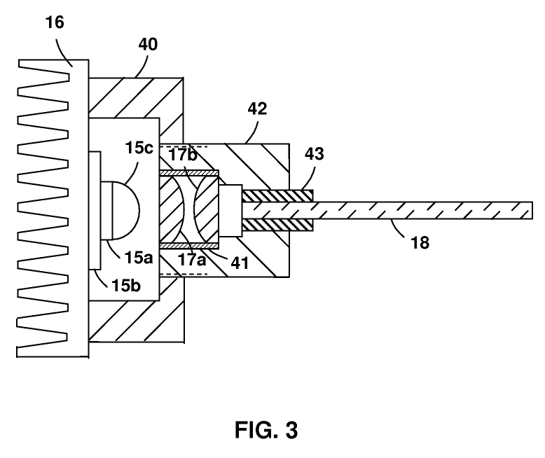

In the present invention, the optical pattern is generated by a fiber array instead of a display device as disclosed in the Parker patent. Thus the total luminous flux of the optical pattern is no longer limited by the size of the display device. In addition, the high lumen loss induced by the incorporation of a display device is avoided. The LED to fiber coupling stage is also designed to achieve a high light coupling efficiency. A more detailed illustration of the LED to fiber coupling stage is shown in FIG. 3. The LED 15 comprises one or more LED chips 15a surface mounted on a thermal conductive substrate 15b. A dome lens 15c coated on the surface of the LED chips 15a is used to control its radiation pattern. The LED 15 may further comprise a reflective cup (not shown in the figure) for better light collection efficiency. The whole LED module is mounted on an aluminum heat sink 16 for improved heat dissipation. The light emitted from the LED 15 is coupled into an optical fiber 18 through a lens set 17. The coupling lens set 17 comprises two pieces of signal lens 17a and 17b, which are designed to have a large relative aperture and a small aberration to achieve high coupling efficiency. The LED 15, the lens set 17 and the fiber 18 are assembled together using fixture 40, 41, 42 and 43 to improve the mechanical and thermal stability of the coupling stage.

In the foregoing specification, specific embodiments of the present invention have been described. However, one of ordinary skill in the art appreciates that various modifications and changes can be made without departing from the scope of the present invention as set forth in the claims below. For example, with the advance of semiconductor technology, LEDs with higher luminance levels will be available in the future. The numerical values cited in the specific embodiment are illustrative rather than limiting. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A projection lighting apparatus for marking and demarcation applications, the lighting apparatus comprising:
a plurality of high intensity light emitting diodes (LEDs);
a plurality of optical fibers with their input ends coupled with each of said plurality of LEDs, and the output ends of said optical fibers are packaged to form an illumination pattern; and
an imaging optical system for projecting said illumination pattern onto a target surface to form an image of said illumination pattern for the marking and demarcation applications.

2. The projection lighting apparatus of claim 1, wherein the optical fiber has a numerical aperture and a core diameter matching with the beam divergence angle and the size of the LED, respectively to obtain a high LED to fiber light coupling efficiency.

3. The projection lighting apparatus of claim 1, wherein each of the LEDs are coupled with the input end of each of the optical fibers through a set of optical lenses with large relative aperture.

4. The projection lighting apparatus of claim 1, wherein the optical intensity distribution of the illumination pattern can be controlled by controlling the intensity of the LEDs and the spatial distribution of the packaged output ends of the optical fibers.

5. The projection lighting apparatus of claim 1, wherein the imaging optical system comprises at least one optical lens.

6. A method for providing projection lighting for marking and demarcation applications, the method comprising the steps of:
providing a plurality of high intensity light emitting diodes (LEDs);
providing a plurality of optical fibers with their input ends coupled with each of said plurality of LEDs and their output ends packaged to form an illumination pattern; and
providing an imaging optical system for projecting said illumination pattern onto a target surface to form an image of said illumination pattern for the marking and demarcation applications.

7. The method of claim 6, wherein the optical fiber has a numerical aperture and a core diameter matching with the beam divergence angle and the size of the LED, respectively to obtain a high LED to fiber light coupling efficiency.

8. The method of claim 6, wherein each of the LEDs are coupled with the input end of each of the optical fibers through a set of optical lenses with large relative aperture.

9. The method of claim 6, wherein the optical intensity distribution of the illumination pattern can be controlled by controlling the intensity of the LEDs and the spatial distribution of the packaged output ends of the optical fibers.

10. The method of claim 6, wherein the imaging optical system comprises at least one optical lens.
